(19) United States
(12) Patent Application Publication
(10) Pub. No.: US 2006/0063123 A1
(43) Pub. Date: Mar. 23, 2006

(54) Hand instrument for self-ligating orthodontic appliances

(75) Inventors: James D. Cleary, Glendora, CA (US); Evangelos G. Georgakis, Alta Loma, CA (US); Ming-Lai Lai, Arcadia, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/948,362

(22) Filed: Sep. 23, 2004

(51) Int. Cl. A61C 3/00; A61C 5/04

(52) U.S. Cl. 433/3; 433/141

(57) ABSTRACT

A hand instrument that is useful for releasing an archwire from an orthodontic appliance includes a shaft and a head. In certain embodiments, the head is pivotally connected to the shaft for movement of the head relative to the shaft to any one of a plurality of orientations. In other embodiments, the head includes a cam section for bearing against the appliance, and the cam section is made of a non-metallic material.

### BACKGROUND OF THE INVENTION

1. Field of the Invention

This invention broadly relates to a hand instrument for releasing orthodontic archwires from self-ligating orthodontic appliances.

2. Description of the Related Art

Orthodontic therapy is a specialized type of treatment within the field of dentistry, and involves movement of malpositioned teeth to improved locations. Orthodontic treatment typically enhances the aesthetic appearance of the patient, especially in regions near the front of the oral cavity. Orthodontic treatment can also improve the patient's occlusion so that the teeth function better with each other during mastication.

Many types of orthodontic treatment programs involve the use of a set of tiny appliances and wires that are commonly known collectively as “braces”. During such treatment programs, small slotted appliances known as brackets are fixed to the patient's anterior, cuspid and bicuspid teeth, and an archwire is inserted into the slot of each bracket. The archwire forms a track to guide movement of the teeth to desired locations. End sections of the archwires are typically captured in tiny appliances known as buccal tubes that are fixed to the patient's molar teeth.

In the past, orthodontic practitioners commonly used elastomeric O-ring ligatures or wire ligatures to connect the archwire to the brackets and to urge the archwire into an orientation of seated engagement with the bottom of the archwire slot. Ligatures are installed by extending the ligatures across the front of the archwire as well as behind tiny protruding hooks known as “tiewings” that extend outwardly from the body of the bracket.

Recently, there has been increased interest in orthodontic appliances that have a latch for coupling the archwire to the appliance. Appliances of this type are widely known as self-ligating appliances and often obviate the need to use ligatures. A number of different types of latches have been proposed, including moveable clips, spring members, covers, shutters, bails and other structure.

Improved self-ligating orthodontic appliances are described in two U.S. Patents entitled “ORTHODONTIC APPLIANCE WITH SELF-RELEASING LATCH”, U.S. Pat. Nos. 6,302,688 and 6,582,226. The appliances described in those patents have a latch for retaining the archwire in the archwire slot, and the latch releases the archwire from the archwire slot whenever the archwire exerts a force on the appliance that exceeds a certain minimum value. The minimum value is significantly less than the force required in the same direction to debond the appliance from the tooth, and consequently helps ensure that the appliance will not spontaneously debond from the tooth during the course of treatment.

U.S. Pat. No. 6,582,226 also describes hand instruments that are especially adapted for use with orthodontic appliances having self-releasing latches. The hand instruments are adapted to open the latch of the appliance when desired in order to intentionally release an archwire from the archwire slot of the appliance. Practitioners often change the archwire during the course of treatment. For example, the practitioner may want to open the latch and remove the existing archwire so that a stiffer archwire can be used near the end of treatment as the teeth move closer to their final desired positions.

The hand instruments described in preferred embodiments of U.S. Pat. No. 6,582,226 have a leg for engagement with the archwire and a cam section for supporting the hand instrument during use. As the practitioner manipulates the hand instrument, the leg of the hand instrument presses the archwire against the latch with sufficient force to open the latch and release the archwire from the archwire slot.

In the field of orthodontics, there is a continuing need to improve devices such as hand instruments and appliances. However, the particular technique of using a hand instrument may vary from practitioner to practitioner. As a consequence, it is usually preferable for any improved hand instrument to be useful in a variety of techniques and with different treatment methods in order to best meet the needs of the practitioner for the particular situation at hand.

### SUMMARY OF THE INVENTION

The present invention relates to improvements in hand instruments for self-ligating appliances that are capable of releasing the archwire from the archwire slot when a force is exerted on the archwire. In certain embodiments of the invention, the hand instrument includes a shaft and a head that is pivotally connected to the shaft. The head is movable to any one of a plurality of orientations so that the practitioner can manipulate the instrument within the confines of the oral cavity according to his or her preferences. The movable head also enables the practitioner to select an orientation of the head that best reduces the likelihood that the hand instrument will unduly impinge against other orthodontic appliances, soft tissue or dentition within the oral cavity.

In other embodiments of the invention, the hand instrument includes a cam section that comprises non-metallic material. As a result, the cam section is less likely to damage the appliance in instances where the cam section bears against the appliance during use. The cam section is particularly beneficial when the hand instrument is used in conjunction with appliances that are made of a material that could be discolored by a metallic camming material, such as appliances made of ceramic or plastic materials.

In more detail, the present invention in one aspect is directed to a hand instrument for self-ligating orthodontic appliances that comprises an elongated shaft including a handle section. The hand instrument also comprises a head including a hook for engaging an archwire. The head also includes a cam section for supporting the head during engagement of the hook with the archwire. The hand instrument further comprises a coupling pivotally connecting the head to the shaft such that the head is movable relative to the handle section to any one of a plurality of orientations.

The present invention is also directed in another aspect to a hand instrument for self-ligating orthodontic appliances. In this aspect, the hand instrument comprises an elongated shaft including a handle section, and a head coupled to the shaft. The head includes a hook and a cam section, and the cam section comprises a non-metallic material.

These and other features of the invention are described in more detail below and are illustrated in the accompanying drawings.

### BRIEF DESCRIPTION OF THE DRAWINGS

FIG. 1 is a perspective view of a hand instrument for self-ligating orthodontic appliances according to one embodiment of the present invention;

FIG. 2 is a plan view of the hand instrument illustrated in FIG. 1;

FIG. 3 is a view somewhat similar to FIG. 2 except that a head of the hand instrument has been moved to a different orientation relative to a shaft of the hand instrument;

FIG. 4 is a view somewhat similar to FIG. 3 except that the head has been moved to yet another orientation relative to the shaft;

FIG. 5 is an enlarged plan view of the head alone of the hand instrument depicted in FIGS. 1-4;

FIG. 6 is an enlarged side cross-sectional view of the head shown in FIG. 5, taken along lines 6-6 of FIG. 5;

FIG. 7 is an enlarged, fragmentary side cross-sectional view of the hand instrument shown in FIGS. 1 and 2 and illustrating a coupling for pivotally connecting the head to the shaft;

FIG. 8 is an enlarged, fragmentary side elevational view of a portion of an outer end of the shaft of the hand instrument shown in FIGS. 1-7, illustrating a cavity for facilitating insertion of an archwire into an archwire slot of the appliance;

FIG. 9 is an enlarged end elevational view of the outer end portion of the shaft illustrated in FIG. 8;

FIG. 10 is a view somewhat similar to FIG. 5 except showing a head of a hand instrument according to another embodiment of the invention;

FIG. 11 is an enlarged, fragmentary view somewhat similar to FIG. 6 except showing a hook of a hand instrument according to still another embodiment of the invention;

FIG. 12 is a view somewhat similar to FIG. 3 except that a hand instrument according to yet another embodiment of the invention is shown; and

FIG. 13 is a side cross-sectional view of the hand instrument shown in FIG. 12, taken along lines 13-13 of FIG. 12.

### DETAILED DESCRIPTION OF THE PREFERRED EMBODIMENTS

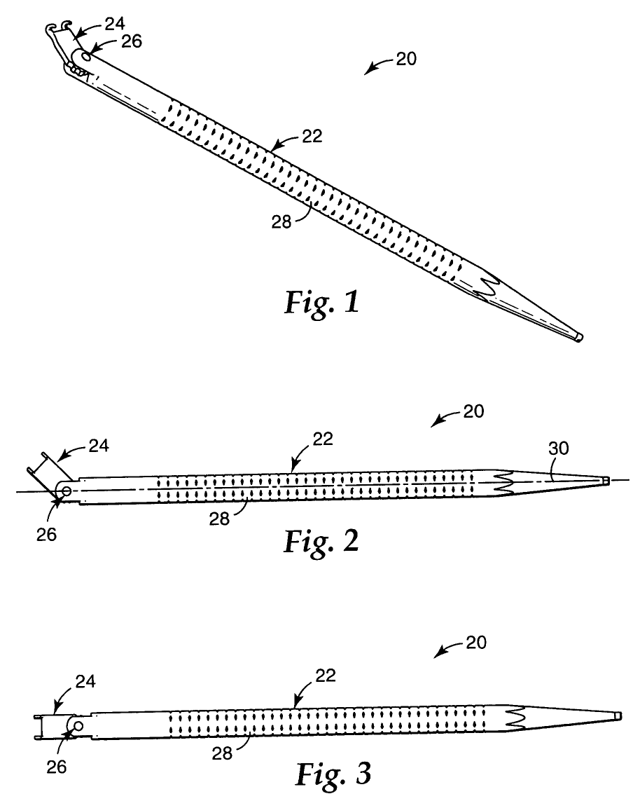

A hand instrument for self-ligating orthodontic appliance according to one embodiment of the invention is illustrated in FIGS. 1-9 and is broadly designated by the numeral 20. The hand instrument 20 includes a shaft 22, a head 24 and a coupling 26 for pivotally connecting the head 24 to the shaft 22.

In more detail, the shaft 22 includes a handle section 28 for griping and manipulating the hand instrument 20. The shaft 22 including the handle section 28 has a central longitudinal axis that is designated by the numeral 30 in FIG. 2.

Preferably, the handle section 28 includes structure for facilitating gripping of the shaft 22 and for enhancing its slip resistance while manipulating the hand instrument 20. In the embodiment shown in the drawings, the handle section 28 has a hexagonal configuration in reference planes perpendicular to the longitudinal axis 30. An outer surface of the handle section 28 is notched along the corners of the hexagonal shape to further facilitate resistance to slippage in the hand of the practitioner.

The head 24 of the hand instrument 20 shown alone in FIGS. 5 and 6, and includes a body 32 that extends along a central reference axis. This axis is designated by the numeral 34 in FIG. 6. The body 32 includes an outer end with a pair of spaced apart, aligned hooks 36. A cam section 38 is located between the hooks 36 for supporting the hand instrument 20 during use.

As used herein, the term “hook” shall mean any curved, bent, angled or protruding structure for catching, holding and/or pulling an archwire. In the embodiment illustrated in the drawings, the hooks 36 have a curved configuration with an undercut recess 40 (see FIG. 6) for receiving an archwire. However, other types of hooks are also possible, such as hooks having a somewhat “L”-shaped configuration without an undercut recess. As other alternatives, the hook may comprise a tab, bump, peg, or other type of protrusion.

An inner end portion of the body 32 remote from the hooks 36 and the cam section 38 includes a circular opening 42 as well as five notches or detents 44. The detents 44 are arranged in spaced-apart relation along a curved edge of the body 32. Preferably, each of the detents 44 is spaced outwardly from the center of the opening 42 an equal, radial distance.

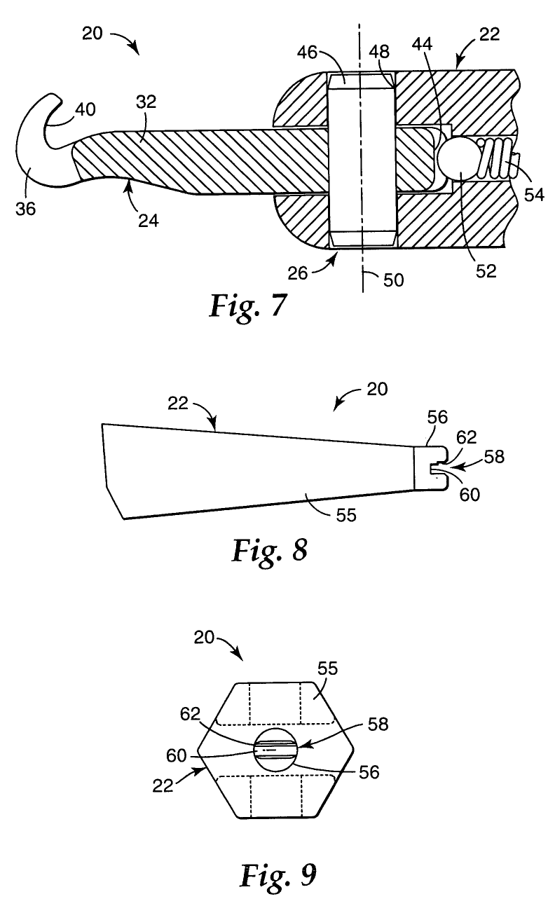

The coupling 26 is shown in more detail in FIG. 7, and includes a generally cylindrical pin 46 that is received in the opening 42 in press-fit relation. The pin 46 also extends in a cylindrical passage 48 that is provided in spaced apart wall sections of an inner, bifurcated end of the shaft 22. The pin 46 pivotally couples the shaft 22 to the head 24 for movement relative to each other in an arc about a reference axis that is designated by the numeral 50 in FIG. 7. The hooks 36 each extend about a reference axis that is perpendicular to the reference axis 50.

Preferably, the coupling 26 includes a yieldable locking member for releasably retaining the head 24 in any one of a plurality of orientations relative to the shaft 22. In the illustrated embodiment, the yieldable locking member comprises a ball 52 (FIG. 7) that is yieldably biased in a direction toward the head 24 by a spring 54. The spring 54 as shown in FIG. 7 is a coil compression spring, although other springs such as leaf springs could be used as well.

As the head 24 is moved about the reference axis 50 relative to the shaft 22, the spring 54 urges the ball 52 against the inner end of the body 32. As one of the detents 44 arrives in a position directly adjacent the ball 52, the spring 54 moves the ball 52 into the detent 44 in order to substantially prevent pivotal movement of the head 24 relative to the shaft 22 during use of the hand instrument 20. However, when it is desired to change the orientation of the head 24 relative to the shaft 22, the practitioner can exert finger pressure on the head 24 and the shaft 22 in a rotative direction about the axis 50. With sufficient finger pressure, a curved side of the detent 44 will bear against the ball 52 with enough force to overcome the bias presented by the spring 54 and push the ball 52 in a direction away from the pin 46. Once the ball 52 is clear of the detent 44, the head 24 can be further moved about axis 50 as desired.

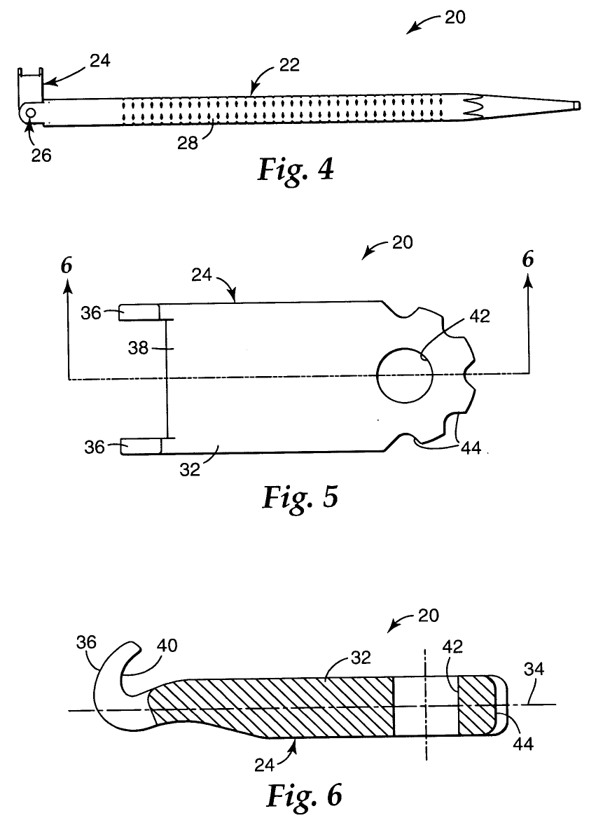

In the embodiment illustrated in FIGS. 1-8, the body 32 includes five detents 44 so that the practitioner can select any one of five different angular orientations of the head 24 relative to the shaft 22. FIGS. 1 and 2 illustrate an example of one of two possible 135 degree angular orientations of the head 24 relative to the shaft 22. FIG. 3 is an illustration where the head 24 and the shaft 22 are aligned along a common axis, representing a 180 degree angular orientation. FIG. 4 is an example of one of two possible 90 degree angular orientations of the head 24 relative to the shaft 22.

The coupling 26 is a significant advantage, in that the practitioner can select the angular orientation of the head 24 relative to the shaft 22 to best facilitate the task at hand. For example, when using the hand instrument 20 in the anterior region of the mouth, the practitioner may prefer to position the head 24 relative to the shaft 22 in the 180 degree angular orientation shown in FIG. 3. In this orientation, the shaft 22 is unlikely to be hindered by adjacent tissue in the oral cavity.

However, when the practitioner is using the hand instrument 20 in posterior regions of the mouth, the practitioner may prefer to shift the head 24 relative to the shaft 22 to the 90 degree angular orientation as depicted in FIG. 4. In this orientation, the hand instrument 20 can be easily manipulated to release the archwire from the archwire slot of the appliance without undue hindrance of the shaft 22 caused by contact of the shaft 22 with the patient's cheeks. Similarly, the practitioner may prefer to use the 135 degree angular orientation shown in FIGS. 1 and 2 in areas adjacent the cuspid teeth. The 135 degree angular orientation may also be useful in posterior regions so long as patient's cheeks do not present significant hindrance to movement of the shaft 22. Additionally, the practitioner may prefer to change the orientation of the head 24 relative to the shaft 22 in accordance with whether the practitioner is left-handed or right-handed.

During use of the hand instrument 20, the hooks 36 exert a force on the archwire. In turn, the archwire bears against the latch of the appliance with sufficient force to open the latch and release the archwire from the archwire slot. During such use, the cam section 38 functions to support the head 24 and to prevent movement of the head 24 in a direction opposite to the direction of the force exerted on the archwire.

Preferably, the cam section 38 bears against the appliance and does not directly bear against the tooth. In this manner, the amount of discomfort that might be otherwise experienced by the patient during the procedure is reduced. Further aspects of the hooks 36 and cam section 38 are described in the aforementioned U.S. Pat. No. 6,582,226, the entire contents of which are expressly incorporated by reference herein.

FIG. 8 is an enlarged fragmentary illustration of an outer end portion of the shaft 22. The outer end portion includes a frustoconical section 55 that is connected to a cylindrical section 56 having a cavity 58. The cavity 58 is useful for releasably retaining and manipulating an archwire in the oral cavity, such as in instances where the archwire is to be guided into the archwire slot of an appliance. The cavity 58 includes a first region 60 for receiving an archwire with a certain cross-sectional configuration and a second region 62 for receiving an archwire having a larger cross-sectional configuration.

The first region 60 and the second region 62 are in communication with each other in the cavity 58. In use, the practitioner manipulates the shaft 22 so that the archwire is received in the cavity 58. If the archwire has a relatively large cross-sectional configuration, the archwire is received in the second region 62 and is too large for reception in the first region 60. However, if the archwire has a relatively small cross-sectional configuration, the archwire will pass through the second region 62 and into the first region 60.

Preferably, the regions 60, 62 are defined by parallel walls that are spaced apart a distance that is complemental to the distance between opposite sides of the smaller archwire and the larger archwire respectively. The parallel sides, in engagement with the archwire, can serve as a wrench to twist the archwire about its long axis as may be needed. Such construction is especially advantageous in instances where a practitioner may need to twist the archwire before it can be inserted into the archwire slot of an appliance mounted on the patient's tooth.

The hand instrument 20, including the shaft 22, the head 24 and the coupling 26, are preferably made of relatively strong and stiff materials that are suitable for use in the oral cavity. Examples of suitable materials include 17-4PH stainless steel and Series 400 stainless steel. The shaft 22 and the head 24 may be machined or made by a metal injection molding process.

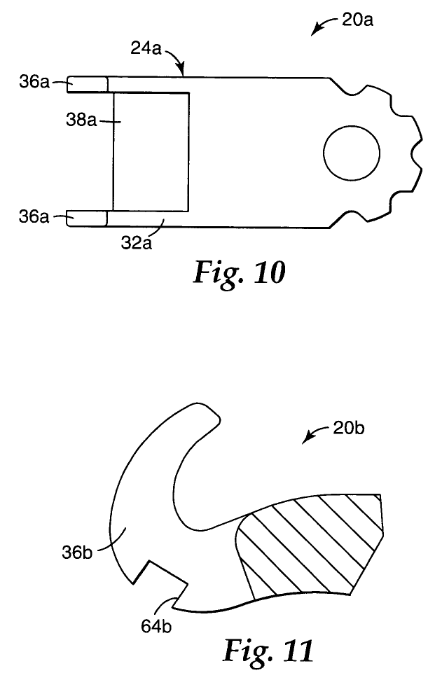

A hand instrument 20a according to another embodiment of the invention includes a head 24a that is illustrated in FIG. 10. The hand instrument 20a also includes a shaft and coupling that are preferably identical to the shaft 22 and coupling 26 described above.

The head 24a includes a cam section 38a that comprises a non-metallic material. Suitable materials include, for example, high strength polymeric materials that are optionally filled with glass fibers. An example of a suitable high strength polymeric material is “Ultem” brand polyetherimide copolymer, 20% glass reinforced, from General Electric Corporation. Other suitable materials include ceramic materials such as polycrystalline aluminum oxide.

Optionally, the cam section 38a comprises a metallic substrate and a non-metallic coating that extends over the substrate. In this instance, the body 32a and the substrate comprise an integral, unitary component. Suitable coatings include, for example, hard carbon coatings such as the coatings described in U.S. Pat. No. 5,203,804, which is hereby expressly incorporated by reference.

Preferably, the non-metallic material can be repeatedly disinfected or sterilized. Preferably, the non-metallic material is resistant to staining so that the hand instrument 20a retains an aesthetic appearance.

The cam section 38a is a particular advantage in instances where the orthodontic appliance is made of a material other than a metallic material. For example, if the appliance is made of a ceramic material such as polycrystalline aluminum oxide, the cam section 38a helps ensure that the areas of the appliance in contact with the cam section 38a are not marked or discolored by the cam section 38a. This aspect is particularly beneficial when the appliance comprises a translucent or transparent material, since the aesthetic appearance of the appliance is maintained.

The cam section 38a may be connected to the body 32a by any one of a number of possible methods. For example, the body 32 may be initially manufactured and the cam section 38a may be molded in place, with projections that fit into recesses or openings of the body 32a. Other means of connecting the cam section 38a to the body 32a are also possible, including fasteners and adhesives.

Optionally, the cam section 38a is removably coupled to the body 32 for replacement when desired. Means for removably coupling the cam section 38a to the body 32a include, for example, threaded fasteners such as machine screws.

Other aspects of the hand instrument 20a are identical to the hand instrument 20. Accordingly, a detailed description of those aspects need not be repeated.

FIG. 11 is an enlarged, fragmentary, cross-sectional view of a hook 36b of a hand instrument 20b according to another embodiment of the invention. Except as described below, the hand instrument 20b is substantially the same as the hand instrument 20 set out above.

The hook 36b includes an outer side or edge portion with a notch 64b. Preferably, the notch 64b has a generally rectangular shape with opposing, parallel walls that are spaced apart from each other. The spacing between the parallel walls is complemental to the distance between opposite sides of an archwire having a rectangular or square configuration in cross-section. The notch 64b can be used to manipulate an archwire, similar to the function of the cavity 58 described above in connection with the hand instrument 20.

Optionally, the notch 64b includes a first and second region, similar to the first and second regions 60, 62 described above. In this manner, the notch 64b can matingly receive archwires of either of two cross-sectional shapes without undue tolerance or “slop”.

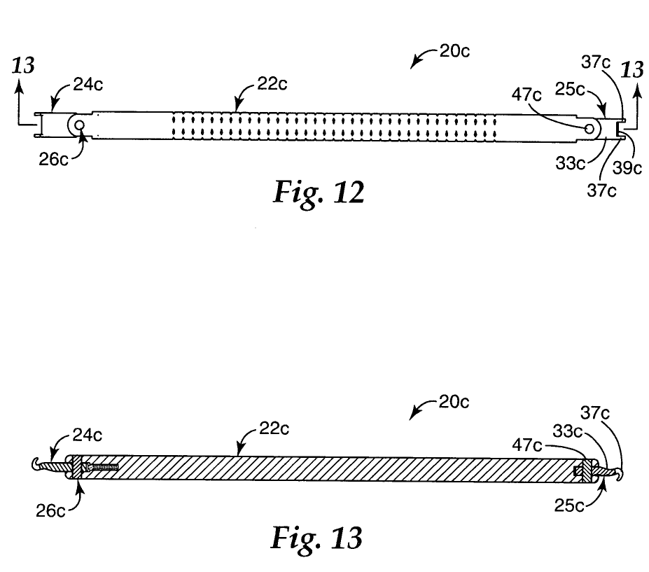

A hand instrument 20c according to another embodiment of the invention is illustrated in FIGS. 12 and 13. The hand instrument includes an elongated shaft 22c and a first head 24c that is coupled to the shaft 22c by a pivotal coupling 26c. Except as described below, the shaft 22c, the head 24c and the coupling 26c are essentially identical to the shaft 22, the head 24 and the coupling 26 respectively.

The hand instrument 20c includes a second head 25c remote from the first head 24c. The second head 25c comprises a body 33c that extends in a direction parallel to, and preferably aligned with, the central longitudinal axis of the shaft 22c. The body 33c includes an outer end with a pair of spaced apart, aligned hooks 37c. In addition, a cam section 39c is located between the hooks 37c for supporting the hand instrument 20c during use.

The hooks 37c and the cam section 39c are essentially the same as the hooks 36 and the cam section 38 described above, except that the hooks 37c are spaced somewhat closer together than the hooks 36. In addition, the width of the cam section 39c in a mesial-distal direction is less than the width of the cam section 38. The reduced width of the cam section 39c and the narrow spacing of the hooks 37c provide an advantage when the hooks 37c are used to release archwires from appliances that are relatively narrow in a mesial-distal direction, such as brackets that are commonly affixed to the patient's anterior teeth. Optionally, and as shown in FIG. 13, the hooks 37c of the head 25c are oriented in an opposite direction relative to the hooks of the head 24c.

In the embodiment depicted in FIGS. 12 and 13, the head 25c is fixedly coupled to the shaft 22c by a pin 47c. The pin 47c extends through a cylindrical passage that is provided in spaced apart wall sections of a bifurcated end of the shaft 22c, similar to the passage 48 shown in FIG. 7. The pin 47c also extends in press-fit relation through an opening of the body 33c that is similar to the opening 42 depicted in FIG. 6. However, the inner end of the body 33c bears in snug fashion against the bottom of the slot presented by the bifurcated end of the shaft 22c and prevents rotation of the head 25c relative to the shaft 22c.

Some practitioners may prefer the stationary position of the head 25c relative to the shaft 22c, since the narrow head 25c is likely to be used only in conjunction with anterior appliances that are relatively easy to access. However, as an alternative, the head 25c may be pivotally connected to the shaft 22c by means of a movement-permitting coupling such as coupling 26 described above. In any event, however, the difference in widths between the heads 24c, 25c provides an advantage in that a single instrument may avoid the need in the opinions of some practitioners to have two hand instruments available and ready for use. The embodiments that are set out above in detail are intended to exemplify the invention, and many variations and additions are possible. For example, the options shown in FIGS. 10 and 11 may be provided on the hand instrument 20c. Accordingly, the invention should not be deemed limited to the specific examples described above, but instead only by a fair scope of the claims that follow along with their equivalents.

1. A hand instrument for a self-ligating orthodontic appliance comprising:
an elongated shaft including a handle section;
a head including a hook for engaging an archwire, the head also including a cam section for supporting the head during engagement of the hook with the archwire; and
a coupling pivotally connecting the head to the shaft such that the head is movable relative to the handle section to any one of a plurality of orientations.

2. A hand instrument according to claim 1 wherein the coupling includes detents to releasably retain the head in any one of a plurality of orientations relative to the handle section.

3. A hand instrument according to claim 2 wherein the coupling includes a yieldable locking member for engagement with the detents.

4. A hand instrument according to claim 3 wherein the locking member comprises a ball.

5. A hand instrument according to claim 4 wherein the coupling includes a spring yieldably biasing the ball to a position of engagement with the detents.

6. A hand instrument according to claim 1 wherein the coupling includes a spring for biasing the head in any one of one or more pre-selected orientations relative to the handle section.

7. A hand instrument according to claim 6 wherein the spring is a coil spring.

8. A hand instrument according to claim 1 wherein the hook includes a curved portion.

9. A hand instrument according to claim 1 wherein the hook includes an undercut region.

10. A hand instrument according to claim 1 wherein the head includes a second hook.

11. A hand instrument according to claim 10 wherein the cam section is located between the hooks.

12. A hand instrument according to claim 1 wherein the hook has an outer side portion with a notch.

13. A hand instrument according to claim 1 wherein the coupling includes a pin.

14. A hand instrument according to claim 1 wherein the coupling pivotally connects the head to the shaft for rotative movement about a first certain reference axis, and wherein the hook extends about a second certain reference axis that is generally perpendicular to the first certain reference axis.

15. A hand instrument according to claim 14 wherein the head includes a second hook, and wherein the second hook extends about the second certain reference axis.

16. A hand instrument according to claim 15 wherein the cam section is located between the hooks.

17. A hand instrument according to claim 1 wherein the shaft includes an outer end portion with a notch, wherein the notch includes a first region for receiving an archwire with a certain cross-sectional configuration, wherein the notch also includes a second region larger than the first region for receiving an archwire with a cross-sectional configuration that is larger than the certain cross-sectional configuration.

18. A hand instrument according to claim 1 wherein the cam section is made of a non-metallic material.

19. A hand instrument according to claim 1 wherein the hand instrument further comprises a second head including a hook for engaging an archwire, the second head also including a cam section for supporting the second head during engagement of the hook with the archwire.

20. A hand instrument according to claim 19 wherein the second head is fixedly connected to the shaft.

21. A hand instrument for a self-ligating orthodontic appliance comprising:
an elongated shaft including a handle section; and
a head coupled to the shaft, wherein the head includes a hook and a cam section, and wherein the cam section comprises a non-metallic material.

22. A hand instrument according to claim 21 wherein the cam section comprises a polymeric material.

23. A hand instrument according to claim 21 wherein the cam section comprises a polymeric material and glass fibers.

24. A hand instrument according to claim 21 wherein the cam section comprises a ceramic material.

25. A hand instrument according to claim 21 wherein the non-metallic material is a coating.

26. A hand instrument according to claim 25 wherein the cam section also comprises a metallic material, and wherein the coating extends over the metallic material.

27. A hand instrument according to claim 21 wherein the head also includes a second hook, and wherein the cam section is located between the hooks.

28. A hand instrument according to claim 21 wherein the head is movable relative to the shaft in an arc about a reference axis.

29. A hand instrument according to claim 28 wherein the hand instrument includes a yieldable locking member for releasably retaining the head in any one of a plurality of orientations relative to the shaft.

30. A hand instrument according to claim 21 wherein the shaft comprises a metallic material, and wherein the cam section comprises a polymeric material.

31. A hand instrument according to claim 30 wherein the cam section also includes glass fibers.

32. A hand instrument according to claim 21 wherein the head comprises a body, and wherein the cam section is removably coupled to the body.
